(19) United States
(12) Patent Application Publication
(10) Pub. No.: US 2005/0272895 A1
(43) Pub. Date: Dec. 8, 2005

(54) Organopolysiloxanes and the use thereof in substances that can be cross-linked at room temperature

(76) Inventors: Wolfgang Ziche, Diera (DE); Uwe Scheim, Coswig (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/527,511

(22) PCT Filed: Sep. 4, 2003
(86) PCT No.: PCT/EP03/09823

§ 371 Date: Mar. 10, 2005

(30) Foreign Application Priority Data
Sep. 12, 2002 (DE) 102 42 415.2

(51) Int. Cl. C08G 77/22; C07F 7/10

(52) U.S. Cl. 528/30; 556/410

(57) ABSTRACT

The invention relates to organopolysiloxanes containing at least one unit of formula (I) R₂SiO_{2/2}, at least one unit of formula (II) (R⁵O)R₂SiO_{1/2}, and at least one unit of formula (III) (R¹R²N—CR¹⁰₂—)RSiO_{2/2}, whereby the radicals and indices have the meanings as cited in Claim 1. The invention also relates to the production of these organopolysiloxanes and to their use in substances that can be cross-linked at room temperature, particularly in those that cross-link while alcohols are separated.

The invention relates to organopolysiloxanes having nitrogen-containing radicals, to the preparation thereof and to the use thereof in room temperature crosslinkable compositions, especially those which crosslink with elimination of alcohols.

Siloxane-based polymers for RTC compositions are common knowledge, such as alkoxysilylalkylene-terminal polymers (see, for example, U.S. Pat. No. 6,037,434) or alkoxysilyl-terminal polymers (see, for example, EP-A 1 006 146). For economic and technical reasons, only a limited range of polymer viscosities is available for the production of RTC rubbers. For low-modulus sealants, however, more highly viscous polymers are required and should preferably be generated from standard polymers in the course of the preparation of RTC compositions.

To increase the viscosity of the polysiloxanes and thus reduce the tension of RTC rubbers produced therefrom, longer polymers can be prepared from shorter polymers by chain extension. It is known that it is possible for this purpose to use difunctional silanes or siloxanes which are thought to have a sufficiently high reactivity. For instance, U.S. Pat. No. 5,110,967 describes Si—N heterocyclic silanes, but these need specific crosslinkers to be used in the formulation of RTC compositions. Compounds such as bisacetamidosilanes (see, for example, U.S. Pat. No. 5,290,826), bisacetoxysilanes (see, for example, U.S. Pat. No. 842,586) or bisaminosilanes (see, for example, EP-A 74 001) release cleavage products in the course of vulcanization which are dangerous to health or corrosive. Bisacetoxysilanes additionally require the addition of aminic compounds (see, for example, U.S. Pat. No. 842,586). Preference is therefore very frequently given to alcohol as a cleavage product, for which the dialkoxysilanes or -siloxanes described in U.S. Pat. No. 5,300,612 and U.S. Pat. No. 5,470,934 are generally unsuitable for a rapid reaction with silanol-terminal siloxanes. When aminomethyldialkoxymethylsilanes are used, a rapid reaction does take place with polysiloxanes, but the resulting polymer is also decomposed again when it is used in RTC compositions in the presence of active hydrogen-containing substances, such as alcohol, which are always present. RTC compositions damaged in this way usually no longer vulcanize.

The invention provides organopolysiloxanes containing at least one unit of the formula
R₂SiO_{2/2} (I)
at least one unit of the formula
(R⁵O) R₂SiO_{1/2} (II)
and at least one unit of the formula
(R¹R²N—CR¹⁰₂—)RSiO_{2/2} (III)
where
R may be the same or different and is a monovalent, optionally substituted hydrocarbon radical,
R′, R³, R⁴, R⁷, R⁸ and R⁹ may each independently be the same or different and be as defined for R,
R¹ and R¹⁰ may each independently be the same or different and be hydrogen or be as defined for R,
R² is a —C(═O)—NH—R³ radical or a —C(═O)(OR⁴) radical,
R⁵ may be the same or different and be a hydrogen or a —(R′₂Si—R⁶—)_{y}Si(OX)ₐR⁷₃₋ₐ radical,
X is —C(═O)—R⁸, —N═CR⁹₂ or is as defined for the R radical,
R⁶ may be the same or different and is a divalent, optionally substituted hydrocarbon radical,
a is 1, 2 or 3 and
y is 0 or 1.

In the context of the present invention, the term organopolysiloxanes shall embrace polymeric, oligomeric and dimeric siloxanes, in which some of the silicon atoms may also be joined to one another by groups other than oxygen, such as via —N— or —C—.

The inventive organopolysiloxanes are preferably those of the formula (IV) 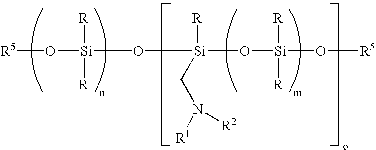
where
R, R¹, R² and R⁵ are each as defined above,
o is ≧1,
m is ≧1 and
n is ≧1,
   with the proviso that the individual units may be distributed in any manner within the molecule.

The values of m, n and o are selected such that the viscosity of the inventive organopolysiloxanes of the formula (IV) is preferably between 5000 and 1 000 000 mPa·s, more preferably between 20 000 and 500 000 mPa·s, in particular between 50 000 and 200 000 mPa·s, based in each case on 20° C.

The inventive organopolysiloxanes are more preferably those of the formula (I) having an n:o ratio of preferably ≧1, more preferably ≧50, in particular ≧100.

The R, R′, R³, R⁴, R⁷, R⁸ and R⁹ radicals are preferably each independently monovalent hydrocarbon radicals optionally substituted by heteroatoms such as nitrogen atoms, halogen atoms and oxygen atoms, and having from 1 to 12 carbon atoms.

Examples of R, R′, R³, R⁴, R⁷, R⁸ and R⁹ radicals are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, and dodecyl radicals such as the n-dodecyl radical; cycloalkyl radicals such as cyclopentyl, cyclohexyl, cycloheptyl and methylcyclohexyl radicals; alkenyl radicals such as the vinyl, 5-hexenyl, cyclohexenyl, 1-propenyl, allyl, 3-butenyl and 4-pentenyl radical; alkynyl radicals such as the ethynyl, propargyl and 1-propynyl radical; aryl radicals such as the phenyl radical; alkaryl radicals such as o-, m-, p-tolyl radicals; and aralkyl radicals such as the benzyl radical, the α- and the β-phenyl-ethyl radical.

Examples of substituted R, R′, R³, R⁴, R⁷, R⁸ and R⁹ radicals are haloalkyl radicals such as 3,3,3-trifluoro-n-propyl radical, the 2,2,2,2′,2′,2′-hexafluoroisopropyl radical, the heptafluoroisopropyl radical and haloaryl radicals such as the o-, m- and p-chlorophenyl radical, and also all radicals mentioned above for R, R′, R³, R⁴, R⁷, R⁸ and R⁹ which may be substituted by mercapto groups, epoxy-functional groups, carboxyl groups, keto groups, enamine groups, amino groups, aminoethylamino groups, isocyanato groups, aryloxy groups, acryloyloxy groups, methacryloyloxy groups, hydroxyl groups and halogen groups.

The R radical is more preferably an alkyl radical having from 1 to 6 carbon atoms, in particular the methyl radical.

The R′ radical is more preferably an alkyl radical having from 1 to 6 carbon atoms, in particular the methyl radical.

The R³ radical is more preferably an alkyl or aryl radical optionally substituted by divalent radicals of the formula —NH—C(═O)—, in particular alkyl radicals having from 1 to 12 carbon atoms.

The R⁴ radical is more preferably an alkyl radical having from 1 to 6 carbon atoms, in particular the methyl and the ethyl radical.

The R⁷ radical is more preferably an alkyl radical having from 1 to 6 carbon atoms, in particular the methyl radical.

The R⁸ radical is more preferably an alkyl radical having from 1 to 6 carbon atoms, in particular the methyl radical.

The R⁹ radical is more preferably an alkyl radical having from 1 to 6 carbon atoms, in particular the methyl or ethyl radical.

The R¹⁰ radical is more preferably a hydrogen atom.

The R¹ radical is preferably a radical specified above for R, more preferably alkyl or aralkyl radicals having from 1 to 12 carbon atoms, in particular the cyclohexyl, methyl or ethyl radical.

The R² is preferably the —C(═O)—NH—R³ radical where R³ is as defined above, more preferably an alkyl radical having from 1 to 6 carbon atoms.

The R⁶ radical is preferably a divalent hydrocarbon radical optionally substituted by heteroatoms such as a nitrogen atom, halogen atom and oxygen atom, and having from 1 to 12 carbon atoms.

Examples of divalent R⁶ radicals are alkylene radicals such as the methylene, ethylene, n-propylene, isopropylene, n-butylene, isobutylene, tert-butylene, n-pentylene, isopentylene, neopentylene, tert-pentylene radical, hexylene radicals such as the n-hexylene radical, heptylene radicals such as n-heptylene radical, octylene radicals such as the n-octylene radical and isooctylene radicals such as the 2,2,4-trimethylpentylene radical, nonylene radicals such as the n-nonylene radical, decylene radicals such as the n-decylene radical, dodecylene radicals such as the n-dodecylene radical; alkenylene radicals such as the vinylene and the allylene radical; cycloalkylene radicals such as cyclopentylene, cyclohexylene, cycloheptylene radicals and methylcyclohexylene radicals; arylene radicals such as the phenylene and the naphthylene radical; alkarylene radicals such as o-, m-, p-tolylene radicals, xylylene radicals and ethylphenylene radicals; aralkylene radicals such as the benzylene radical, the α- and the β-phenylethylene radical.

The R⁶ radical is more preferably an ethylene or propylene radical, in particular the ethylene radical.

y is preferably 0.

a is preferably 2.

X is preferably as defined for the R radical or —N═CR⁹₂, particular preference being given to the methyl radical.

The R⁵ radical is more preferably an alkoxysilyl group or hydrogen atom, in particular an alkoxysilyl radical.

Examples of the inventive organopolysiloxanes are HO—(Me₂SiO)₅₀₀—SiMe[CH₂—NCy-(C=O)NHCy]—(OSiMe₂)₅₀₀—OH, (MeO)₂MeSi—O—(Me₂SiO)₆₅₀—SiMe[CH₂NCy-(C═O)NHCy]—(OSiMe₂)₆₅₀—O—SiMe(OMe)₂, HO—(Me₂SiO)₅₀₀—{SiMe[CH₂—NCy-(C═O)NHCy]—(OSiMe₂)₅₀₀—O}₃H and (MeO)₂MeSi—O—(Me₂SiO)₁₀₀₀—{SiMe[CH₂—NCy-(C═O)NHCy]—(OSiMe₂)₁₀₀₀—O}₂—SiMe(OMe)₂, where Cy is a cyclohexyl and Me is a methyl radical.

The inventive organopolysiloxanes have the advantage that they have a high stability with respect to degradation during storage.

In addition, the inventive organopolysiloxanes have the advantage that they can be used universally in condensation-crosslinking compositions, without polymer degradation and thus disruptions to vulcanization occurring.

The inventive organopolysiloxanes may be prepared by any processes known in organosilicon chemistry.

In a preferred procedure, in a
first step, hydroxy-terminated organopolysiloxanes are reacted with silanes of the formula
   R¹HN—CH₂—SiR(OR¹¹)₂ (V)
   and/or partial hydrolyzates thereof, where R and R¹ are each as defined above and R¹¹ may be the same or different and be as defined for R, and, in a
second step, the amino groups of the reaction product obtained in the first stage are converted to urea groups or carbamate groups using compounds selected from isocyanates, reactive isocyanate derivatives and reactive carboxylic acid derivatives, for example carboxylic anhydrides or carbonyl chlorides.

If further branching of the inventive organopolysiloxanes is desired, it is possible in the second step of the process according to the invention, for example, also to use oligofunctional isocyanates, so that a plurality of siloxane polymers, for example of the type of the formula (I), can be bonded via the R³ radical.

In a particularly preferred procedure, in a
first step, hydroxy-terminated organopolysiloxanes are reacted with silanes of the formula
   R¹HN—CH₂—SiR(OR¹¹)₂ (V)
   and/or partial hydrolyzates thereof, where R and R¹ are each as defined above and R¹¹ may be the same or different and be as defined for R, and, in a
second step, the amino groups of the reaction product obtained in the first stage are converted to urea groups using isocyanates.

If desired, the organopolysiloxanes prepared in accordance with the invention may subsequently be end-capped in a third step with organosilicon compounds, for example silanes of the formula Si(OX)_{a′}R⁷_{4-a′} (VI), by customary methods which are known to those skilled in the art of siloxane chemistry, where X and R⁷ are each as defined above and a′ is 2, 3 or 4.

The present invention further provides a process for preparing the inventive organopolysiloxanes, characterized in that,
in a first step, hydroxy-terminated organopolysiloxanes are reacted with silanes of the formula
   R¹HN—CH₂—SiR(OR¹¹)₂ (V)
   and/or partial hydrolyzates thereof, where R and R¹ are each as defined above and R¹¹ may be the same or different and be as defined for R,
in a second step, the amino groups of the reaction product obtained in the first stage are converted to urea groups or carbamate groups using compounds selected from isocyanates, reactive isocyanate derivatives and reactive carboxylic acid derivatives, and,
optionally in a third step, the organopolysiloxanes obtained in the second step are end-capped with silanes of the formula Si(OX)_{a′}R⁷_{4-a′} (VI) where X and R⁷ are each as defined above and a′ is 2, 3 or 4.

Examples of the silanes of the formula (V) used in the process according to the invention are CyHN—CH₂—Si(CH₃)(OCH₂CH₃)₂, C₆H₅—CH₂—HN—CH₂—Si(CH₃)(OCH₃)₂ and (H₃C—CH₂)HN—CH₂—Si(CH₃)(OCH₂CH₃)₂, where Cy is the cyclohexyl radical.

In the first step of the process according to the invention, silanes of the formula (V) are used in amounts such that the molar Si—OH/OR¹¹ ratio is preferably greater than or equal to 1.

Examples of isocyanates which can be used in the second step of the process according to the invention are cyclohexyl isocyanate, isophorone diisocyanate or hexamethylene diisocyanate.

Examples of reactive isocyanate derivatives which can be used in the second step of the process according to the invention are the reaction products of the abovementioned isocyanates with phenol or caprolactam.

Examples of carboxylic acid derivatives which can be used in the second step of the process according to the invention are acetic anhydride and acetyl chloride.

If isocyanates are used in the second step of the process according to the invention, they are preferably used in molar amounts of from 100 to 120%, based on the silanes of the formula (V) used.

If carboxylic acid derivatives are used in the second step of the process according to the invention, they are preferably used in molar amounts of 100-130%, based on the silanes of the formula (V) used.

If the third step of the process according to the invention is carried out, silanes of the formula (VI) are used preferably in amounts of from 1 to 5 parts by weight, based on 100 parts by weight of the hydroxy-terminated polysiloxane used.

The components used in the process according to the invention may each be one type of such a component or else a mixture of at least two types of a particular component.

The process according to the invention is carried out at temperatures of preferably from 5 to 100° C., more preferably at room temperature, i.e. about 20° C., and a pressure of the surrounding atmosphere, i.e. from about 900 to 1100 hPa.

The individual steps of the process according to the invention may be carried out separately or as what is known as a one-pot reaction in one reaction vessel.

During the inventive reaction, R¹¹—OH is formed and may remain in the reaction mixture or be removed by known methods, where R¹¹ is as defined above.

Overall, the result is thus a production process which includes exclusively fast reactions, so that the process according to the invention may be carried out either continuously or batchwise.

The process according to the invention has the advantage that it is rapid and simple to carry out, and readily available raw materials are used as reactants.

A particular advantage of the process according to the invention is that it can be conducted as a one-pot reaction (or gradual reaction in the case of continuous production), since no deactivation whatsoever of any additives or a workup of the organopolysiloxane prepared after one of the substeps is necessary.

A further advantage of the process according to the invention is that the organopolysiloxanes prepared may be used further directly, for example in the preparation of RTC compositions.

The inventive organopolysiloxanes or those which are prepared in accordance with the invention may be used for all purposes for which organopolysiloxanes have also been used hitherto. In particular, are suitable for the preparation of room temperature crosslinkable compositions.

The present invention further provides compositions crosslinkable by condensation reaction, characterized in that they comprise inventive organopolysiloxanes or those which are prepared in accordance with the invention.

In addition to the inventive organopolysiloxanes, the inventive compositions comprise all components which have also been used hitherto for the preparation of room temperature crosslinkable organopolysiloxane compositions, known as RTC compositions. The hydrolyzable groups which the organosilicon compounds involved in the crosslinking reaction may have may be any groups such as acetoxy, oximato and organyloxy groups, such as ethoxy radicals, alkoxyethoxy radicals and methoxy radicals, the compositions preferably being single-component compositions crosslinkable at room temperature by means of organyloxy groups.

Examples of components which can be used in the preparation of the inventive RTC compositions are condensation catalysts, reinforcing fillers, nonrein-forcing fillers, pigments, soluble dyes, odorants, plasticizers such as room temperature liquid dimethylpolysiloxanes end-capped by trimethylsiloxy groups or phosphoric esters, fungicides, resinous organopolysiloxanes, including those composed of (CH₃)₃SiO_{1/2} and SiO_{4/2} units, purely organic resins such as homo- or copolymers of acrylonitrile, of styrene, of vinyl chloride or of propylene, in which case such purely organic resins, in particular copolymers of styrene and n-butyl acrylate, may have been generated by free-radical polymerization of the monomers mentioned actually in the presence of diorganopolysiloxane having in each case one Si-bonded hydroxyl group in the terminal units, corrosion inhibitors, polyglycols which may be esterified and/or etherified, oxidation inhibitors, heat stabilizers, solvents, agents for influencing the electrical properties such as conductive black, flame retardants, light stabilizers and agents for prolonging the skin formation time, such as silanes having SiC-bonded mercaptoalkyl radicals, and also cell-generating agents for example azodicarbonamide. It is equally possible to add adhesion promoters, preferably aminoalkyl-functional silanes such as γ-aminopropyltriethoxysilane.

To prepare the inventive compositions, preference is given to using condensation catalysts. The condensation catalysts may be any which have also been present hitherto in compositions which are storable with the exclusion of water and crosslink at room temperature on ingress of water to give elastomers.

Examples of such condensation catalysts are organic compounds of tin, zinc, zirconium, titanium and aluminum. Preference is given among these condensation catalysts to butyl titanates and organic tin compounds such as di-n-butyltin diacetate, di-n-butyltin dilaurate, and reaction products of silane having, as hydrolyzable groups, at least two monovalent hydrocarbon radicals per molecule which are bonded to silicon via oxygen and optionally substituted by an alkoxy group, or oligomer thereof, with diorganotin diacylate, all valencies of the tin atoms in these reaction products being saturated by oxygen atoms of the ≡SiOSn≡ moiety or by SnC-bonded monovalent organic radicals.

The inventive RTC compositions preferably comprise fillers. Examples of fillers are nonreinforcing fillers, i.e. fillers having a BET surface area of up to 50 m²/g, such as quartz, diatomaceous earth, calcium silicate, zirconium silicate, zeolites, metal oxide powders such as oxides of aluminum, titanium, iron or zinc, or mixed oxides thereof, barium sulfate, calcium carbonate, gypsum, silicon nitride, silicon carbide, boron nitride, glass and plastic powder, such as polyacrylonitrile powder; reinforcing fillers, i.e. fillers having a BET surface area of more than 50 m²/g, such as pyrogenic silica, precipitated silica, carbon black such as furnace black and acetylene black, and silicon-aluminum mixed oxides of large BET surface area; fibrous fillers such as asbestos and plastic fibers.

The fillers mentioned may be hydrophobicized, for example by the treatment with organosilanes or -siloxanes or with stearic acid, or by etherification of hydroxyl groups to alkoxy groups. In the case of the sole use of reinforcing silica as a filler, transparent RTC compositions may be prepared.

The components used to prepare the inventive compositions may each be one type of such a component or else a mixture of at least two different types of a particular component.

The inventive crosslinkable compositions are preferably those which comprise
(A) inventive organopolysiloxanes,
(B) crosslinkers having at least three organyloxy radicals,
(C) condensation catalysts and
(D) filler.

The inventive crosslinkable compositions are more preferably those which comprise
(A) inventive organopolysiloxanes,
(B) from 0.01 to 5 parts by weight, based on 100 parts by weight of (A), of silanes having at least three alkoxy radicals and/or partial hydrolyzates thereof,
(C) from 0.01 to 3 parts by weight, based on 100 parts by weight of (A), of condensation catalysts and
(D) from 0.5 to 20 parts by weight, based on 100 parts by weight of (A), of filler.

The inventive compositions may be prepared in any manner known hitherto, for example by simply mixing the individual components, in which case inventive siloxane used as component (A) may be prepared in situ.

For the crosslinking of the inventive RTC compositions, the typical water content of air is sufficient. If desired, the crosslinking may also be carried out at temperatures higher or lower than room temperature, for example at from −5 to 10° C. or at from 30 to 50° C. The crosslinking is carried out preferably at a pressure of the surrounding atmosphere, i.e. from about 900 to 1100 hPa.

The present invention provides moldings produced by crosslinking the inventive compositions.

The inventive compositions may be used for all purposes for which compositions crosslinkable at room temperature by condensation reaction have also been used hitherto. They are thus suitable in an excellent manner, for example, as sealing compositions for joints, including vertical joints, and similar cavities, for example of buildings, land vehicles, watercraft and aircraft, or as adhesives or cementing compositions, for example in window construction or in the production of display cases, and also for producing protective coatings or elastomeric moldings, and also for the insulation of electrical or electronic devices. The inventive RTC compositions are especially suitable as low-modulus sealing compositions for joints with possible high accommodation of motion.

In the examples described below, all specifications of parts with percentages, unless stated otherwise, are based on the weight. In addition, all viscosity data are based on a temperature of 20° C. Unless stated otherwise, the examples below are carried out at a pressure on the surrounding atmosphere, i.e. at about 1000 hPa, and room temperature, i.e. at about 20° C., or at a temperature which is established when the reactants are combined at room temperature without additional heating or cooling.

Below, Cy stands for cyclohexyl radical.

### EXAMPLE 1

500 parts by weight of a silanol-terminal dimethylpolysiloxane having a viscosity of 1000 mPa·s, 500 parts by weight of a trimethylsilyl-terminal dimethylpolysiloxane having a viscosity of 100 mPa·s are mixed with 4 parts by weight of a silane of the formula CyHN—CH₂—Si(CH₃)(OCH₂CH₃)₂ in a planetary mixer, and the viscosity η¹ is determined and reproduced in Table 1. This polymer mixture is admixed with 2 parts by weight of cyclohexyl isocyanate, and, after 5 minutes, 30 parts by weight of methyltrimethoxysilane and 0.15 part by weight of zinc acetylacetonate are added for catalysis. The course of the viscosity is measured and reproduced in Table 1.

### COMPARATIVE EXAMPLE 1

500 parts by weight of a silanol-terminal dimethylpolysiloxane having a viscosity of 1000 mPa·s, 500 parts by weight of a trimethylsilyl-terminal dimethylpolysiloxane having a viscosity of 100 mPa·s are mixed with 4 parts by weight of a silane of the formula (CH₃CH₂)₂N—CH₂—Si(CH₃)(OCH₂CH₃)₂ in a planetary mixer, and the viscosity η¹ is determined and reproduced in Table 1. Afterward, 30 parts by weight of methyltrimethoxysilane and 0.15 part by weight of zinc acetylacetonate are added for catalysis. The course of the viscosity is measured and reproduced in Table 1.

TABLE 1
Viscosity in mPa · s

| | Example 1 | Comparative example 1 |
|---|---|---|
| η¹ | 1312 | 560 |
| η after 2 hours | 992 | 480 |
| η after 2 days | 960 | 200 |
| η after 3 days | 864 | 170 |

### EXAMPLE 2

In a planetary mixer, 50.0 parts by weight of a silanol-terminal dimethylpolysiloxane having a viscosity of 80 000 mPa·s, 30.0 parts by weight of a trimethylsilyl-terminal dimethylpolysiloxane having a viscosity of 100 mPa·s are mixed with 0.1 part by weight of a silane of the formula CyHN—CH₂—Si(CH₃)(OCH₂CH₃)₂ and stirred for 5 minutes. This polymer mixture is admixed with 0.07 part by weight of cyclohexyl isocyanate, and, after 5 minutes, 3.0 parts by weight of methyltrimethoxysilane and 0.015 part by weight of zinc acetylacetonate are added for catalysis. As soon as the silanol content is <30 ppm, a solid RTC preparation is compounded using 1.2 parts by weight of 3-aminopropyltrimethoxysilane, 8.5 parts by weight of a pyrogenic silica (BET 150 m²/g) and 0.3 part by weight of a tin catalyst which is prepared by reacting di-n-butyltin diacetate and tetraethoxysilane. The thus obtained composition is applied in a thickness of 2 mm to a PE film and stored at 23° C./50% rel. atmospheric humidity. The skin formation time is 15 minutes; the composition cures through within 24 hours and results in an elastic vulcanized material.

### COMPARATIVE EXAMPLE 2

In a planetary mixer, 50.0 parts by weight of a silanol-terminal dimethylpolysiloxane having a viscosity of 80 000 mPa·s, 30.0 parts by weight of a trimethylsilyl-terminal dimethylpolysiloxane having a viscosity of 100 mPa·s are mixed with 0.1 part by weight of a silane of the formula (CH₃CH₂)₂N—CH₂—Si(CH₃)(OCH₂CH₃)₂ and stirred for 5 minutes. Then, 3.0 parts by weight of methyltrimethoxysilane and 0.015 part by weight of zinc acetylacetonate are added. As soon as the silanol content is <30 ppm, a solid RTC preparation is compounded using 1.2 parts by weight of 3-aminopropyltrimethoxysilane, 8.5 parts by weight of a pyrogenic silica (BET 150 m²/g) and 0.3 part by weight of a tin catalyst which is prepared by reacting di-n-butyltin diacetate and tetraethoxysilane. The composition is applied in a thickness of 2 mm to a PE film and stored at 23° C./50% rel. atmospheric humidity. The skin formation time is 15 minutes; however, the composition does not cure through and does not give an elastic vulcanized material.

### EXAMPLE 3

In a planetary mixer, 50.0 parts by weight of a silanol-terminal dimethylpolysiloxane having a viscosity of 80 000 mPa·s, 30.0 parts by weight of a trimethylsilyl-terminal dimethylpolysiloxane having a viscosity of 100 mPa·s are mixed with 0.1 part by weight of a silane of the formula CyHN—CH₂—Si(CH₃)(OCH₂CH₃)₂ and stirred for 5 minutes. This polymer mixture is admixed with 0.07 part by weight of cyclohexyl isocyanate, and, after 5 minutes, 3.0 parts by weight of ethyltriacetoxysilane are added. 8.5 parts by weight of a pyrogenic silica (BET 150 m²/g) and 0.01 part by weight of dibutyltin diacetate are used to compound a solid RTC preparation. The composition is applied in a thickness of 2 mm to a PE film and stored at 23° C./50% rel. atmospheric humidity. The skin formation time is 10 minutes; the composition cures through within 24 hours and results in an elastic vulcanized material.

1-8. (canceled)

9. An organopolysiloxane, comprising:
at least one unit of the formula
R₂SiO_{2/2} (I)
at least one unit of the formula
(R⁵O)R₂SiO_{1/2} (II)
and at least one unit of the formula
(R¹R²N—CR¹⁰₂—)RSiO_{2/2} (III)
where
R each is the same or different and is a monovalent, optionally substituted hydrocarbon radical,
R′, R³, R⁴, R⁷, R⁸ and R⁹ are each independently the same or different and are as defined for R,
R¹and R¹⁰ are each independently the same or different and are hydrogen or are as defined for R,
R² independently is a —C(═O)—NH—R³ radical or a —C(═O)(OR⁴) radical,
R⁵ each is the same or different and is hydrogen or a —(R′₂Si—R⁶—)_{y}Si(OX)ₐR⁷₃₋ₐ radical,
X is —C(═O)—R⁸, —N═CR⁹₂ or is as defined for the R radical,
R⁶ each is the same or different and is a divalent, optionally substituted hydrocarbon radical,
a is 1, 2 or 3, and
y is 0 or 1.

10. The organopolysiloxane of claim 9, comprising 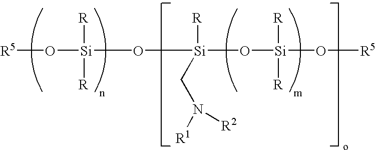
where
o is ≧1,
m is ≧1 and
n is ≧1,
wherein the n and o moieties are distributed in any manner within the molecule.

11. The organopolysiloxane of claim 10, wherein the values for m, n and o are selected such that the viscosity of the organopolysiloxane is between 5000 and 1,000,000 mPa·s at 20° C.

12. A process for preparing an organopolysiloxane of claim 9, comprising:
a) reacting hydroxy-terminated organopolysiloxane(s) with silane(s) of the formula
R¹HN—CH₂—SiR(OR¹¹)₂ (V)
and/or partial hydrolyzates thereof, where each R¹¹ is the same or different and is as defined for R,
b) converting amino groups of the reaction product obtained in a) to urea groups or carbamate groups by reacting with one or more compounds selected from the group consisting of isocyanates, reactive isocyanate derivatives, and reactive carboxylic acid derivatives, and,
c) optionally, end-capping organopolysiloxane(s) obtained in b) with one or more silanes of the formula Si(OX)_{a′}R⁷_{4-a′} (VI) where a′ is 2, 3 or 4.

13. The process of claim 12, wherein amino groups of the reaction product obtained in a) are converted in b) to urea groups by reacting with isocyanate.

14. A condensation crosslinkable composition, comprising at least one organopolysiloxane (A) of claim 9.

15. A condensation crosslinkable composition, comprising at least one organopolysiloxane (A) prepared by the process of claim 12.

16. The crosslinkable composition of claim 14, further comprising
(B) from 0.01 to 5 parts by weight, based on 100 parts by weight of (A), of silane(s) having at least three alkoxy radicals and/or partial hydrolyzates thereof,
(C) from 0.01 to 3 parts by weight, based on 100 parts by weight of (A), of condensation catalyst(s) and
(D) from 0.5 to 20 parts by weight, based on 100 parts by weight of (A), of filler(s).

17. A molding produced by crosslinking the composition of claim 14.

18. A molding produced by crosslinking the composition of claim 15.

19. A crosslinkable composition, comprising
(A) at least one organopolysiloxane of claim 10,
(B) from 0.01 to 5 parts by weight, based on 100 parts by weight of (A), of silane(s) having at least three alkoxy radicals and/or partial hydrolyzates thereof,
(C) from 0.01 to 3 parts by weight, based on 100 parts by weight of (A), of condensation catalyst(s) and
(D) from 0.5 to 20 parts by weight, based on 100 parts by weight of (A), of filler(s).
